(19) United States
(12) Patent Application Publication
(10) Pub. No.: US 2021/0164158 A1
(43) Pub. Date: Jun. 3, 2021

(54) TEXTILE PRINTING

(71) Applicant: Hewlett-Packard Development Company, L.P., Spring, TX (US)

(72) Inventors: Jie ZHENG, San Diego, CA (US); Dennis Z. GUO, San Diego, CA (US)

(73) Assignee: Hewlett-Packard Development Company, L.P., Spring, TX (US)

(21) Appl. No.: 16/770,839

(22) PCT Filed: Apr. 16, 2018
(86) PCT No.: PCT/US2018/027766

§ 371 Date: Jun. 8, 2020

(51) Int. Cl. D06P 5/30; C09D 11/322; C09D 11/104; D06P 5/20; D06P 1/52; B41M 5/00; B41M 7/00; B41J 2/05

(52) U.S. Cl. CPC D06P 5/30; C09D 11/322; C09D 11/104; D06P 5/2077; D06P 3/605; B41M 5/0041; B41M 5/0023; B41M 7/009; B41J 2/05; D06P 1/5285

(57) ABSTRACT

The present disclosure includes methods of printing on textiles. The method can include jetting an ink composition onto a fabric substrate. The ink composition can include water, organic co-solvent, pigment, and from 2 wt % to 15 wt % of a sulfonated polyester-polyurethane binder. The method can also include heating the fabric substrate having the ink composition printed thereon to a temperature from 120° C. to 200° C. for a period of 30 seconds to 5 minutes.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BREIF DESCRIPTION OF DRAWINGS

FIG. 1 provides a flow diagram for an example method of printing textiles in accordance with examples herein;

FIG. 2 schematically depicts an example textile printing system including an ink composition and a fabric substrate in accordance with examples herein; and

FIG. 3 schematically depicts an alternative example textile printing system including an ink composition, a fabric substrate, a thermal inkjet printhead, and a heat curing device in accordance with examples herein.

### DETAILED DESCRIPTION

The present technology relates to printing on fabric using pigmented ink composition. The ink composition can include a predominant amount of water, organic co-solvent, and in some examples, additional liquid vehicle ingredients, etc. In addition to dispersed pigment solids, the ink compositions can also include a sulfonated polyester-polyurethane binder. There are textile printing methods that can be used to print on cotton or other natural fibers, and other textile printing methods that can be used to print on synthetic fibers, such as nylon. However, to find a system that performs acceptably on both types of fabric and can be thermally jetted from thermal inkjet printheads provides a versatility that is not as common in the textile printing industry. This is because ink that may otherwise be more easily jettable from thermal inkjet architectures often are not as durable on fabric after undergoing a vigorous washing protocol. Likewise, inks that tend to work well on multiple types of fabrics are often not as easily jettable from thermal inkjet printheads.

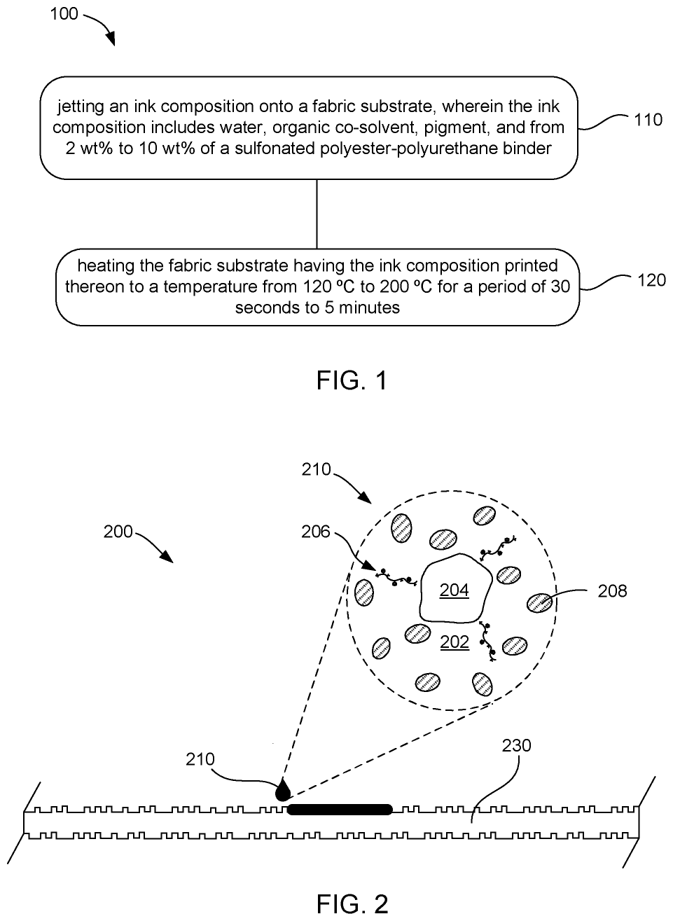

In accordance with this, the present disclosure is drawn to a method of printing textiles, shown by example at 100 in FIG. 1, and can include jetting 110 an ink composition onto a fabric substrate and heating 120 the fabric substrate having the ink composition printed thereon to a temperature from 120° C. to 200° C. for a period of 30 seconds to 5 minutes. The ink composition can include water, organic co-solvent, pigment, and from 2 wt % to 15 wt % of a sulfonated polyester-polyurethane binder. In various examples, the sulfonated polyester-polyurethane binder can include diaminesulfonate groups, can have a weight average molecular weight from 20,000 Mw to 300,000 Mw, can have an acid number from 1 to 50, and/or can have an average particle size from 20 nm to 500 nm. The sulfonated polyester-polyurethane binder can be aliphatic including multiple saturated carbon chain portions ranging from C₄ to C₈ in length and be devoid of aromatic moieties. In another example, the sulfonated polyester-polyurethane binder can be aromatic including both aromatic moieties as well as saturated carbon chain portions ranging from C₄ to C₈ in length. In one example, the fabric substrate can include cotton, polyester, nylon, or a blend thereof. In another example, jetting can be from a thermal inkjet printhead.

Alternatively, a textile printing system, shown by example at 200 in FIG. 2, can include a fabric substrate 230 and an ink composition 210. The ink composition can include from 60 wt % to 90 wt % water and from 5 wt % to 30 wt % organic co-solvent (as liquid vehicle 202 fluids, for example), from 1 wt % to 6 wt % pigment 204, and from 2 wt % to 15 wt % of sulfonated polyester-polyurethane binder 208 having an average particle size from 20 nm to 500 nm. In some examples, the pigment can have a dispersant 206 associated with a surface thereof, such as a dispersing polymer, or it can be self-dispersed, for example. In another example, the sulfonated polyester-polyurethane binder can include diaminesulfonate groups. The sulfonated polyester-polyurethane binder can have a weight average molecular weight from 20,000 Mw to 300,000 Mw, an acid number from 1 to 50, and/or an average particle size from 20 nm to 500 nm. In further detail, the sulfonated polyester-polyurethane binder can be aliphatic and include multiple saturated carbon chain portions ranging from C₄ to C₈ in length. In another example, the sulfonated polyester-polyurethane binder can be aromatic and can include both aromatic moieties as well as saturated carbon chain portions ranging from C₄ to C₈ in length. The fabric substrate can include cotton, polyester, nylon, or a blend thereof.

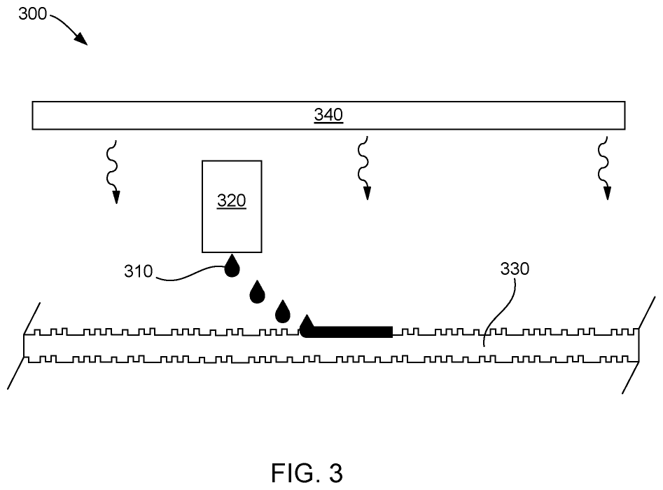

In further detail, a textile printing system, shown by example at 300 in FIG. 3, can include a fabric substrate 330, ink composition 310, a thermal inkjet printer 320 to thermally eject the ink composition on the fabric substrate, and a heat curing device 340 to heat the ink composition after application onto the fabric substrate. The ink composition can include water, organic solvent, pigment, and from 2 wt % to 15 wt % sulfonated polyester-polyurethane binder. Ink composition 31 can be similar to that shown 210 in FIG. 2, for example. In further detail, the fabric substrate can include cotton, polyester, nylon, or a blend thereof.

As a note, with respect to the textile printing methods and systems described herein, various specific descriptions can be considered applicable to other examples whether or not they are explicitly discussed in the context of that example. Thus, for example, in discussing a pigment related to the methods of printing on textiles, such disclosure is also relevant to and directly supported in context of the textile printing systems, and vice versa.

Turning to more specific detail regarding the components of the ink compositions that can be used for the methods and systems described herein, the pigment can be any of a number of pigments of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155.

The pigment can be dispersed by a dispersant, such as a styrene (meth)acrylate dispersant, or another dispersant suitable for keeping the pigment suspended in the liquid vehicle. For example, the dispersant can be any dispersing (meth)acrylate polymer, or other type of polymer, such as maleic polymer or a dispersant with aromatic groups and a poly(ethylene oxide) chain. In on example, however, the (meth)acrylate polymer can be a styrene-acrylic type dispersant polymer, as it can promote Tr-stacking between the aromatic ring of the dispersant and various types of pigments, such as copper phthalocyanine pigments, for example. In one example, the styrene-acrylic dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene-acrylic dispersant can have an acid number from 100 to 350, from 120 to 350, from 150 to 300, from 180 to 250, or about 214, for example. Example commercially available styrene-acrylic dispersants can include Joncryl®671, Joncryl®71, Joncryl®96, Joncryl®680, Joncryl®683, Joncryl® 678, Joncryl® 690, Joncryl® 296, Joncryl® 671, Joncryl®696 or Joncryl®ECO 675 (all available from BASF Corp., Germany).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). This can be the case for either dispersant polymer for pigment dispersion or for dispersed polymer binder that may include co-polymerized acrylate and/or methacrylate monomers. Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

Pigments and dispersants have been described separately above, but there are several more specific example combinations that can be used. For example, the pigment can be carbon black pigment with a styrene acrylic dispersant; PB 15:3 (cyan pigment) with styrene acrylic dispersant or with a self-dispersed moiety attached to a surface thereof; PR122 (magenta) or a combination PR122/PV19 (magenta) with styrene acrylic dispersant or with a self-dispersed moiety attached to a surface thereof; PY74 (yellow) or PY155 (yellow) with styrene acrylic dispersant. When the styrene acrylic dispersant is used, molecular weights of the polymer dispersant can be from 7,000 Mw to 12,000 Mw, or from 8,000 Mw to 11,000 Mw, for example. The acid number of the styrene acrylic dispersant can be from 150 to 200, or from 155 to 185, for example. Two of the pigments colorants mentioned herein are described as including a self-dispersed moiety. Those self-dispersed pigments can be obtained from Cabot Corporation (USA) Cabojet® 250C (cyan) and Cabojet® 265M (magenta).

In further detail, the ink compositions can also include a sulfonated polyester-polyurethane binder that is dispersed therein. The sulfonated polyester-polyurethane binder can have an average particle size from 20 nm to 500 nm, from 50 nm to 350 nm, or from 100 nm to 250 nm, for example. The particle size of any solids herein, including the average particle size of the dispersed polymer binder, can be determined using a Nanotrac® Wave device, from Microtrac, e.g., Nanotrac® Wave II or Nanotrac® 150, etc, which measures particles size using dynamic light scattering. Average particle size can be determined using particle size distribution data generated by the Nanotrac® Wave device. The weight average molecular weight can be from 50,000 Mw to 500,000 Mw, from 100,000 Mw to 400,000 Mw, or from 150,000 Mw to 300,000 Mw. The acid number of the sulfonated polyester-polyurethane binder can be from 1 mg KOH/g to 200 mg KOH/g, from 2 mg KOH/g to 100 mg KOH/g, or from 3 mg KOH/g to 50 mg KOH/g, for example. Even with the sulfonate groups, these binders are generally not very soluble in the water and organic co-solvent liquid vehicle, and thus can be considered to be a dispersed polymer. Example sulfonated polyester-polyurethane binders can include aliphatic or aromatic polyester-polyurethanes with sulfonate groups. In further detail, the weight average molecular weight of the sulfonated polyester-polyurethane binder can be from 20,000 Mw to 500,000 Mw, from 35,000 Mw to 400 Mw, from 50,000 Mw to 300 Mw, from 20,000 mw to 100,000 Mw, or from 100,000 Mw to 500,000 Mw.

In one example, the sulfonated polyester-polyurethane binder can be anionic. In further detail, the sulfonated polyester-polyurethane binder can also be aliphatic including saturated carbon chains therein as part of the polymer backbone or side-chain thereof, e.g., C2 to C10, C3 to C8, or C3 to C6 alkyl. These polyester-polyurethane binders can be described as “alkyl” or “aliphatic” because these carbon chains are saturated and because they are devoid of aromatic moieties. An example anionic aliphatic polyester-polyurethane binder that can be used is Impranil® DLN-SD (CAS# 375390-41-3; Mw 133,000 Mw; Acid Number 5.2; Tg −47° C.; Melting Point 175-200° C.) from Covestro (Germany). Example components used to prepare the Impranil® DLN-SD or other similar anionic aliphatic polyester-polyurethane binders can include pentyl glycols, e.g., neopentyl glycol; C4-C8 alkyldiol, e.g., hexane-1,6-diol; C3 to C5 alkyl dicarboxylic acids, e.g., adipic acid; C4 to C8 alkyl diisocyanates, e.g., hexamethylene diisocyanate (HDI); diamine sulfonic acids, e.g., 1-[(2-aminoethyl)amino]-ethanesulfonic acid; etc. Alternatively, the polyester-polyurethane binder can be aromatic (or include an aromatic moiety) along with aliphatic chains. An example of an aromatic polyester-polyurethane binder that can be used is Dispercoll® U42 (CAS# 157352-07-3). Example components used to prepare the Dispercoll® U42 or other similar aromatic polyester-polyurethane binders can include aromatic dicarboxylic acids, e.g., phthalic acid; C4 to C8 alkyl dialcohols, e.g., hexane-1,6-diol; C4 to C8 alkyl diisocyanates, e.g., hexamethylene diisocyanate (HDI); diamine sulfonic acids, e.g., 1-[(2-aminoethyl)amino]-ethanesulfonic acid; etc. Other types of polyester-polyurethanes can also be used, including Impranil® DL 1380, which can be somewhat more difficult to jet from thermal inkjet printheads compared to Impranil® DLN-SD and Dispercoll® U42, but still can be acceptably jetted in some examples, and can also provide acceptable washfastness results on a variety of fabric types. Conversely, other types of polyurethanes (other than the polyester-type polyurethanes) do not tend to perform as well when jetting from thermal inkjet printheads and/or do not perform as well on fabric substrates, e.g., some jet acceptably but do not provide good washfastness, others provide good washfastness but are thermally jetted poorly, and others perform poorly in both categories. In still further detail, the pigmented ink compositions with polyethylene polyurethane binder can provide acceptable to good washfastness durability on a variety of substrates, making this a versatile ink composition for fabric printing, e.g., cotton, polyester, cotton/polyester blends, nylon, etc.

The ink compositions of the present disclosure can be formulated to include an aqueous liquid vehicle, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorant, etc. However, as part of the ink composition used in the systems and methods described herein, the pigment, dispersant, and the sulfonated polyester-polyurethane binder can be included or carried by the liquid vehicle components. Suitable pH ranges for the ink composition can be from pH 7 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8.

In further detail regarding the aqueous liquid vehicle, the co-solvent(s) can be present and can include any co-solvent or combination of co-solvents that is compatible with the pigment, dispersant, and sulfonated polyester-polyurethane binder. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The aqueous liquid vehicle can also include surfactant and/or emulsifier. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol^{TM} surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives known to those skilled in the art to modify properties of the ink as desired.

Thus, the textile printing methods and systems described herein can be suitable for printing on many types of textiles, such as cotton fibers, including treated and untreated cotton substrates, polyester substrates, cotton/polyester blends, nylons, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

As mentioned, in some examples, the fabric substrate can include natural fiber and synthetic fiber, e.g., cotton/polyester blend. The amount of each fiber type can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

It is notable that the term “fabric substrate” or “fabric media substrate” does not include materials commonly known as any paper (even though paper can include multiple types of natural and synthetic fibers or mixtures of both types of fibers). Fabric substrates can include textiles in filament form, textiles in the form of fabric material, or textiles in the form of fabric that has been crafted into a finished article, e.g., clothing, blankets, tablecloths, napkins, towels, bedding material, curtains, carpet, handbags, shoes, banners, signs, flags, etc. In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process, e.g., a solvent treatment, a mechanical treatment process, e.g., embossing, a thermal treatment process, or a combination of multiple processes.

The fabric substrate can have a basis weight ranging from about 10 gsm to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition, the fabric substrate can contain additives including, but not limited to, colorant (e.g., pigments, dyes, and tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

Regardless of the substrate, whether natural, synthetic, blend thereof, treated, untreated, etc., the fabric substrates printed with the ink composition of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). Essentially, by measuring OD and/or L*a*b* both before and after washing, ΔOD and ΔE value can be determined, which is essentially a quantitative way of expressing the difference between the OD and/or L*a*b* prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of about)275°), ii) compensation for neutral colors or the primed values in the L*C*h differences, iii) compensation for lightness (S_{L}), iv) compensation for chroma (S_{c}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the latex polymers disclosed herein. This value can be determined, in one example, by dissolving or dispersing a known quantity of a material in organic solvent and then titrating with a solution of potassium hydroxide (KOH) of known concentration for measurement. Acid number values or ranges can be shown either with or without notating the specific units, e.g., mg KOH/g.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1

### Preparation of Ink Compositions

Twenty-two (22) ink compositions were prepared with two different pigment dispersions (K1 and M1) and eleven (11) different polyurethane dispersion binders (PU1-PU11) using a common ink composition formulation shown in Table 1.

TABLE 1
Pigmented Polyurethane Ink Composition Formulations

| | | Concentration |
|---|---|---|
| Ingredient | Category | (wt %) |
| Glycerol | Organic Co-solvent | 6 |
| LEG-1 | Organic Co-solvent | 1 |
| Crodafos ® N3 Acid | Surfactant/Emulsifier | 0.5 |
| Surfynol ® 440 | Surfactant | 0.3 |
| Acticide ® B20 | Biocide | 0.22 |
| *Polyurethane | Dispersed polymer | 6 (PU content) |
| (PU1-PU11) | binder | |
| **Pigment (K1 or M1) | Dispersed Pigment | 2 (pigment content) |
| Deionized Water | Water | Balance |

Crodafos ® is from Croda International Plc. (Great Britain).
Surfynol ® is from Evonik Industries AG (Germany).
Acticide ® B20 is from Thor Specialties (USA).
*Eleven (11) different polyurethanes tested, including Polyester-Polyurethanes (PU1-PU3), Polyether- Polyurethanes (PU4-PU8), Polycarbonateester-polyether- Polyurethanes (PU9), and Polycarbonate- Polyurethanes (PU10-PU11), as more specifically identified in Table 2.
**Two different pigments were tested, including black pigment dispersion K1 and magenta dispersion M1.

### Example 2

### Thermal Jettability of Pigmented Polyurethane Ink Compositions

The black and magenta ink compositions of Example 1 were tested for thermal jettability including evaluation of drop weight, drop velocity, internal energy curve (which is the response of drop weight to firing energy), decel performance (which is the response of drop velocity to a continuous firing over 6 seconds), and decap performance (which refers to the amount of time that a print head may be left uncapped before the printer nozzle no longer fires properly, potentially because of clogging or plugging.). Based on this evaluation, a score was given to the various inks tested indicating jettability performance from a thermal inkjet printhead (12 ng). Table 2 provides the scores achieved for the various ink compositions. The polyurethane samples tested are grouped in Table 2 by polyurethane-type.

TABLE 2
Thermal Jettability Performance of Pigmented Ink
Compositions with Various Types of Polyurethane

| Pigment | PU- | PU- | PU- | |
|---|---|---|---|---|
| ID | ID | Type | Tradename | Jettability |
| K1 and M1 | PU1 | Polyester | Impranil ® DLN-SD | Good |
| K1 and M1 | PU2 | | Dispercoll ® U42 | Good |
| K1 and M1 | PU3 | | Impranil ® DL 1380 | Marginal |
| K1 and M1 | PU4 | Polyether | Impranil ® LP DSB | Marginal |
| | | | 1069 | |
| K1 and M1 | PU5 | | Hydran ® WLS-201 | Very Poor |
| K1 and M1 | PU6 | | Hydran ® WLS-201K | Very Poor |
| K1 and M1 | PU7 | | Takelac ® W-6061T | Poor |
| K1 and M1 | PU8 | | Takelac ® WS-6021 | Very Poor |
| K1 and M1 | PU9 | Polycarbonate | Impranil ® DLU | Very Poor |
| | | ester-polyether | | |
| K1 and M1 | PU10 | Polycarbonate | Hydran ® WLS 213 | Very Poor |
| K1 and M1 | PU11 | | Takelac ® W-6110 | Very Poor |

K1 is a carbon black dispersed by a styrene acrylic polymer (8,000 Mw/AN 155).
M1 is PR122/PV19 pigment dispersed by styrene acrylate polymer (1,0000 Mw/AN 172).
Impranil ® and Dispercoll ® are available from Covestro (Germany).
Hydran ® is available from DIC Corporation (Japan).
Takelac ® is available from Mitsui (Japan).

### Example 3

### Washfastness of Pigmented Polyurethane Ink Compositions

The black ink compositions and the magenta ink compositions of Example 1 were screened for washfastness on three different types of fabrics, namely cotton (natural fibers), cotton/polyester (natural/synthetic fibers), and nylon (synthetic fibers). Table 3A provides the data collected from the eleven (11) black inks prepared and evaluated, and Table 3B provides the data collected from the eleven (11) magenta inks prepared. In printing the various ink composition samples on the three different types of fabric, 3 drops per pixel (600 dpi) durability plots (where each drop was about 12 ng) were printed from a thermal inkjet printhead. After printing, the samples were allowed to dry and were heat cured at 150° C. for 3 minutes. The printed fabric samples were then evaluated to obtain L*a*b* color space values, which represented the “pre-washing” values, or reference black or magenta values. Then, the printed fabric substrates were washed at 40° C. with laundry detergent (e.g., Tide® available from Proctor and Gamble, Cincinnati, Ohio, USA) for 5 cycles, air drying the printed fabric substrates between washing cycles. After the five cycles, L*a*b* values were measured for comparison. The delta E (ΔE) values were calculated using the 1976 standard denoted as ΔE_{CIE}. The data is provided in Tables 3A and 3B, as follows:

TABLE 3A
Washfastness of Black Pigmented Polyurethane
Ink Compositions on Natural Fabric, Natural/Synthetic
Fabric Blend, and Synthetic Fabric

| Pigment | | | ΔE_{CIE} | ΔE_{CIE} | ΔE_{CIE} |
|---|---|---|---|---|---|
| ID | ^{†} PU-ID | PU-Type | Cotton | Cotton/Polyester | Nylon |
| K1 | PU1 | Polyester | 4.6 | 5 | 4.6 |
| K1 | PU2 | | 3.9 | 6.1 | 7.1 |
| K1 | PU3 | | 6.3 | 7.2 | — |
| K1 | PU4 | Polyether | 7.6 | 7.9 | — |
| K1 | PU5 | | 7 | 9.9 | 18 |
| K1 | PU6 | | 5.7 | 9.3 | 9.9 |
| K1 | PU7 | | 2.9 | 6.1 | — |
| K1 | PU8 | | 1.7 | 6 | |
| K1 | PU9 | Polycarbonate | 6.3 | 7.2 | — |
| | | ester-polyether | | | |
| K1 | ^{‡} PU10 | Polycarbonate | — | — | — |
| K1 | PU11 | | 1.3 | 4.4 | — |

^{†} Polyurethane Tradenames for PU1-PU11 identified in Table 2.
^{‡} PU-10 was tested for washfastness using the Magenta Ink.

TABLE 3B
Washfastness of Magenta Pigmented Polyurethane
Ink Compositions on Natural fabric, Natural/Synthetic
Fabric Blend, and Synthetic Fabric

| Pigment | | | ΔE_{CIE} | ΔE_{CIE} | ΔE_{CIE} |
|---|---|---|---|---|---|
| ID | ^{†}PU-ID | PU-Type | Cotton | Cotton/Polyester | Nylon |
| M1 | PU1 | Polyester | 5.5 | 6.7 | 5.3 |
| M1 | PU2 | | 4 | 4.6 | 5.7 |
| M1 | PU3 | | 5.9 | 7.4 | — |
| M1 | PU4 | Polyether | 6.9 | 8.8 | — |
| M1 | PU5 | | 8.1 | 11.3 | 27.8 |
| M1 | PU6 | | 6 | 8.8 | 19.8 |
| M1 | PU7 | | 2.6 | 6.5 | — |
| M1 | PU8 | | 1.1 | 5.8 | — |
| M1 | PU9 | Polycarbonate | 7.9 | 8 | — |
| | | ester-polyether | | | |
| M1 | PU10 | Polycarbonate | 1.9 | — | 4.1 |
| M1 | PU11 | | 1.9 | 4.4 | — |

^{†}PU-Tradenames for PU1-PU11 identified in Table 2

In Tables 3A and 3B above, ΔE of less than 4 was considered good performance, ΔE of 4 to 7.5 was considered acceptable performance, ΔE from 7.5 to about 15 was considered poor performance, and above about 15 was considered very poor performance. As demonstrated, the polyester-type polyurethane exhibited a combination of both good thermal jettability (See Table 2) and from acceptable to good washfastness (See Tables 3A and 3B) on all three types of fabric, including natural fabric (cotton), natural/synthetic blend fabric (cotton/polyester), and synthetic fabric (nylon) fabrics. Impranil® DLN-SD and Dispercoll® U42, both from Covestro (Germany) and both polyurethane-polyesters, exhibited good thermal jettability and both exhibited at least acceptable washfastness. In one instance on cotton, black pigmented ink with Impranil® DLN-SD performed in the good range with respect to both jettability and washfastness. Even the Impranil® DL 1380, which performed in the acceptable category with respect to jettability, still outperformed the ink compositions using other types of polyurethane when considering both parameters together.

### Example 4

### Preparation of Pigmented Polyurethane-Polyester Ink Compositions

Based on the data collected in Tables 3A and 3B, a more involved study of the two best performing binders, which were both sulfonated polyester-polyurethane binders, was conducted. Specifically, two sulfonated polyurethane-polyester binders, namely Impranil® DLN-SD (PU1) and Dispercoll® U42 (PU2), were studied for ink stability and washfastness with ten (10) different pigment dispersions (K1-K2, C1-C3, M1-M2, and Y1-Y3). Table 4A provides the general ink composition details used to prepare the various ink samples, and Table 4B provides a specific Ink ID for the specific sulfonated polyester-polyurethane binders as combined with one of the ten (10) different pigment dispersions (for a total of 13 ink compositions). The pigment dispersion wt % is based on pigment content, but the pigments as described include a dispersant associated with a surface thereof. As a note, the Impranil® DLN-SD (PU1) was formulated with 9 different pigment dispersions, namely two black pigment dispersions (K1-K2), three cyan dispersions (C1-C3), two magenta dispersions (M1-M2), and two yellow pigment dispersion (Y1-Y2); whereas the Dispercoll® U42 (PU2) was prepared using one pigment dispersion for black (K1) and one pigment dispersion for the various remaining colors (C1, M1, and Y3).

TABLE 4A
Pigmented Polyester-Polyurethane Ink Formulation

| | | Concentration |
|---|---|---|
| Ingredient | Category | (wt %) |
| Glycerol | Organic Co-solvent | 6 |
| LEG-1 | Organic Co-solvent | 1 |
| Crodafos ® N3 Acid (Croda | Surfactant/ | 0.5 |
| International Pic. - Great | Emulsifier | |
| Britain) | | |
| Surfynol ® 440 | Surfactant | 0.3 |
| (Evonik - Germany) | | |
| Acticide ® B20 | Biocide | 0.22 |
| (Thor Specialties - USA) | | |
| * Polyurethane (PU1 or PU2) | Dispersed polymer | 6 (PU content) |
| | binder | |
| * Pigment (K, C, M, or Y) | Dispersed Pigment | 2 (pigment content) |
| Deionized Water | Water | Balance |

Crodafos ® is from Croda International Plc. (Great Britain).
Surfynol ® is from Evonik Industries AG (Germany).
Acticide ® B20 is from Thor Specialties (USA).
* Specific Polyurethane and Pigment Dispersion combinations identified in Table 4A.

TABLE 4B
Ink Compositions Prepared from Table 4A Ink Composition
Formulation, Selected Polyester-Polyurethane Binder,
and Selected Pigment Dispersion

| | Pigment | | Polyester- | PE- |
|---|---|---|---|---|
| Ink | Dispersion | | Polyurethane | PU |
| ID | ID | Color Index/Dispersant | (PE-PU) | ID |
| Ink 1 | K1 | Carbon Black/Styrene | Impranil ® | PU1 |
| | | Acrylic (8,000 Mw; AN 155) | DLN-SD | |
| Ink 2 | K2 | Carbon Black/Styrene | Impranil ® | PU1 |
| | | Acrylic (8,000 Mw; AN 165) | DLN-SD | |
| Ink 3 | C1 | PB 15:3/Styrene Acrylic | Impranil ® | PU1 |
| | | (8,000 Mw; AN 185) | DLN-SD | |
| Ink 4 | C2 | PB 15:3/Self-Dispersed | Impranil ® | PU1 |
| | | Cabojet ® 250C | DLN-SD | |
| Ink 5 | C3 | PB 15:3/Styrene Acrylic | Impranil ® | PU1 |
| | | (8,000 Mw; AN 165) | DLN-SD | |
| Ink 6 | M1 | PR122/PV19; Styrene | Impranil ® | PU1 |
| | | Acrylic (10,000 Mw; AN172) | DLN-SD | |
| Ink 7 | M2 | PR122; Self-Dispersed | Impranil ® | PU1 |
| | | Cabojet ® 265M | DLN-SD | |
| Ink 8 | Y1 | PY74/Styrene Acrylic | Impranil ® | PU1 |
| | | (11,000 Mw; AN 185) | DLN-SD | |
| Ink 9 | Y2 | PY155/Styrene Acrylic | Impranil ® | PU1 |
| | | (8,000 Mw; AN155) | DLN-SD | |
| Ink 10 | K1 | Carbon Black/Styrene | Dispercoll ® | PU2 |
| | | Acrylic (8,000 Mw; AN 155) | U42 | |
| Ink 11 | C1 | PB 15:3/Styrene Acrylic | Dispercoll ® | PU2 |
| | | (8,000 Mw; AN 185) | U42 | |
| Ink 12 | M1 | PR122/PV19; Styrene | Dispercoll ® | PU2 |
| | | Acrylic (10,000 Mw; AN172) | U42 | |
| Ink 13 | Y3 | PY74/Styrene Acrylic | Dispercoll ® | PU2 |
| | | (11,000 Mw; AN 185) | U42 | |

Impranil ® are Dispercoll ® are polyester-polyurethane dispersions available from Covestro (USA).

### Example 5

### Ink Composition Stability

Particle size distribution data was collected for the thirteen (13) ink compositions prepared in accordance with Example 4 (Tables 4A and 4B). To evaluate stability, initial volume average particle size (Mv) was collected using a NanoTrac® 150 particle size system. The pigment particle sizes were then determined again using the NanoTrae 150 system after undergoing either freeze-thaw cycling (T-cycle) or accelerated shelf-life (ASL) stress. The freeze-thaw cycling (T-cycle) included 5 freeze-thaw cycles where 30 mL samples were brought to an initial temperature of 70° C. in 20 minutes and then maintained at 70° C. for 4 hours. The samples were then decreased from 70° C. to −40° C. in 20 minutes and maintained at −40° C. for 4 hours. This process was repeated so that the samples were subjected to a total of 5 freeze-thaw cycles. Following the fifth cycle, the samples were allowed to equilibrate to room temperature and the average particle sizes were tested. With respect to accelerated shelf-life (ASL), 30mL samples were stored in an oven at 60° C. for 7 days. Following the elevated temperature storage period, the samples were allowed to equilibrate to room temperature and the particle sizes were tested.

The results of the stability testing are shown in Table 5, where: Mv=Volume Averaged Particle Size; T-cycle Mv=after 5 Freeze-Thaw Cycles from −40° C. to 70° C.; ASL Mv=after Accelerated Shelf Life at 60° C. for 1 week; and % Δ32 Percentile Change from Initial Particle Size (Mv) Compared to After T-cycle or ASL.

TABLE 5
Volume Averaged Particle Size Stability

| | Initial Mv | T-cycle Mv | T-cycle Mv | ASL Mv | ASL Mv |
|---|---|---|---|---|---|
| Ink ID | (μm) | (μm) | (% Δ) | (μm) | (% Δ) |
| Ink 1 | 0.176 | 0.151 | −14.3 | 0.146 | −16.9 |
| Ink 2 | 0.173 | 0.13 | −24.7 | 0.14 | −19.1 |
| Ink 3 | 0.102 | 0.097 | −4.8 | 0.099 | −3.5 |
| Ink 4 | 0.104 | 0.104 | 0.6 | 0.1 | −3.7 |
| Ink 5 | 0.127 | 0.129 | 1.3 | 0.122 | −4.3 |
| Ink 6 | 0.163 | 0.146 | −10.2 | 0.138 | −15 |
| Ink 7 | 0.154 | 0.15 | −2.7 | 0.119 | −23 |
| Ink 8 | 0.126 | 0.124 | −1.8 | 0.117 | −7.1 |
| Ink 9 | 0.212 | 0.198 | −6.5 | 0.183 | −13.7 |
| Ink 10 | 0.186 | 0.188 | 1.5 | 0.175 | −5.6 |
| Ink 11 | 0.119 | 0.117 | −1.6 | 0.116 | −2.4 |
| Ink 12 | 0.189 | 0.189 | −0.1 | 0.192 | 1.6 |
| Ink 13 | 0.153 | 0.168 | 9.8 | 0.143 | −6.3 |

### Example 6

### Washfastness of Pigmented Ink Compositions with Polyester-Polyurethane Binder

Inks 1-13 described in Tables 4A and 4B were tested for washfastness on various substrates, such as Jacquard cotton (cotton with pretreatment), gray cotton, cotton/polyester blend, nylon, and polyester. Not all ink compositions were evaluated on every fabric substrate, but representative data was collected from every fabric type using both types of sulfonated polyester-polyurethane binder. The washfastness protocol carried out was that as described in Example 3, except that both ΔE_{CIE} and ΔE₂₀₀₀ data was collected. Furthermore, raw optical density (OD) data is also provided for pre-wash and post-wash as well.% ΔOD was also calculated. The OD and ΔE data is provided in Tables 6A to 6E, as follows:

TABLE 6A
OD and Washfastness of Four (4) Pigmented Polyester-
Polyurethane Ink Compositions on Jacquard Cotton

| Ink ID/ | OD | OD | | | |
|---|---|---|---|---|---|
| Pigment ID | (pre-wash) | (post-wash) | % ΔOD | ΔE_{CIE} | ΔE₂₀₀₀ |
| Ink 1/K1 | 1.241 | 1.237 | −0.36 | 2.01 | 1.81 |
| Ink 3/C1 | 1.229 | 1.167 | −5.04 | 2.23 | 1.35 |
| Ink 6/M1 | 1.139 | 1.115 | −2.15 | 2.08 | 0.71 |
| Ink 8/Y1 | 1.185 | 1.086 | −8.36 | 5.67 | 1.17 |

All ink compositions included Impranil ® DLN-SD

TABLE 6B
OD and Washfastness of Thirteen (13) Pigmented Polyester-
Polyurethane Ink Compositions on Gray Cotton

| Ink ID/ | OD | OD | | | |
|---|---|---|---|---|---|
| Pigment ID | (pre-wash) | (post-wash) | % ΔOD | ΔE_{CIE} | ΔE₂₀₀₀ |
| Ink 1/K1 | 1.110 | 0.993 | −10.5 | 4.81 | 4.06 |
| Ink 2/K2 | 1.139 | 0.990 | −13.1 | 5.20 | 4.34 |
| Ink 3/C1 | 1.131 | 1.017 | −10.1 | 4.01 | 2.42 |
| Ink 4/C2 | 1.213 | 1.029 | −15.2 | 5.24 | 3.40 |
| Ink 5/C3 | 1.114 | 0.990 | −11.1 | 4.63 | 2.67 |
| Ink 6/M1 | 1.014 | 0.924 | −8.9 | 4.59 | 1.85 |
| Ink 7/M2 | 0.973 | 0.889 | −8.6 | 4.85 | 2.13 |
| Ink 8/Y1 | 1.106 | 0.957 | −13.4 | 7.58 | 1.60 |
| Ink 9/Y2 | 0.921 | 0.836 | −9.2 | 5.34 | 1.26 |
| Ink 10/K1 | 1.080 | 1.001 | −7.4 | 3.91 | 3.33 |
| Ink 11/C1 | 1.063 | 0.967 | −9.1 | 3.92 | 2.53 |
| Ink 12/M1 | 0.951 | 0.889 | −6.5 | 4.02 | 1.75 |
| Ink 13/Y3 | 0.956 | 0.867 | −9.3 | 4.81 | 1.10 |

Inks 1-9 included Impranil ® DLN-SD.
Inks 10-13 included Dispercoll ® U42.

TABLE 6C
OD and Washfastness of Ten (10) Pigmented Polyester-
Polyurethane Ink Compositions on Polyester/Cotton Blend

| Ink ID/ | OD | OD | | | |
|---|---|---|---|---|---|
| Pigment ID | (pre-wash) | (post-wash) | % ΔOD | ΔE_{CIE} | ΔE₂₀₀₀ |
| Ink 1/K1 | 1.110 | 0.954 | −14.0 | 5.75 | 4.85 |
| Ink 2/K2 | 1.111 | 0.919 | −17.3 | 7.24 | 6.14 |
| Ink 3/C1 | 1.109 | 0.938 | −15.4 | 4.74 | 3.56 |
| Ink 6/M1 | 0.984 | 0.861 | −12.5 | 5.99 | 2.93 |
| Ink 8/Y1 | 1.053 | 0.909 | −13.7 | 7.88 | 1.72 |
| Ink 9/Y2 | 0.918 | 0.770 | −16.1 | 8.24 | 1.97 |
| Ink 10/K1 | 1.121 | 0.996 | −11.2 | 6.12 | 5.12 |
| Ink 11/C1 | 1.105 | 0.967 | −12.5 | 5.50 | 4.28 |
| Ink 12/M1 | 1.000 | 0.899 | −10.1 | 4.62 | 2.49 |
| Ink 13/Y3 | 1.016 | 0.872 | −14.1 | 6.72 | 1.54 |

Inks 1-3, 6, 8-9 included Impranil ® DLN-SD.
Inks 10-13 included Dispercoll ® U42.

TABLE 6D
OD and Washfastness of Thirteen (13) Pigmented Polyester-
Polyurethane Ink Compositions on Nylon

| Ink ID/ | OD | OD | | | |
|---|---|---|---|---|---|
| Pigment ID | (pre-wash) | (post-wash) | % ΔOD | ΔE_{CIE} | ΔE₂₀₀₀ |
| Ink 1/K1 | 1.133 | 1.029 | −9.2 | 3.89 | 3.20 |
| Ink 2/K2 | 1.135 | 1.035 | −8.8 | 3.20 | 2.61 |
| Ink 3/C1 | 1.104 | 1.039 | −5.8 | 3.81 | 2.99 |
| Ink 4/C2 | 1.170 | 1.114 | −4.8 | 3.80 | 3.29 |
| Ink 5/C3 | 1.165 | 1.093 | −6.1 | 2.41 | 1.87 |
| Ink 6/M1 | 1.043 | 0.993 | −4.8 | 2.72 | 1.36 |
| Ink 7/M2 | 1.051 | 0.975 | −7.2 | 3.16 | 1.86 |
| Ink 8/Y1 | 1.151 | 1.077 | −6.4 | 3.44 | 0.82 |
| Ink 9/Y2 | 1.067 | 1.010 | −5.3 | 2.37 | 0.52 |
| Ink 10/K1 | 1.126 | 0.968 | −14.0 | 7.14 | 5.97 |
| Ink 11/C1 | 1.082 | 0.949 | −12.3 | 5.66 | 3.99 |
| Ink 12/M1 | 1.012 | 0.931 | −8.0 | 5.69 | 2.68 |
| Ink 13/Y3 | 1.072 | 0.978 | −8.8 | 5.64 | 1.22 |

Inks 1-9 included Impranil ® DLN-SD.
Inks 10-13 included Dispercoll ® U42.

TABLE 6E
OD and Washfastness of Thirteen (13) Pigmented Polyester-
Polyurethane Ink Compositions on Polyester

| Ink ID/ | OD | OD | | | |
|---|---|---|---|---|---|
| Pigment ID | (pre-wash) | (post-wash) | % ΔOD | ΔE_{CIE} | ΔE₂₀₀₀ |
| Ink 1/K1 | 1.096 | 0.976 | −11.0 | 4.26 | 3.58 |
| Ink 2/K2 | 1.127 | 0.958 | −15.0 | 6.35 | 5.30 |
| Ink 3/C1 | 1.088 | 0.960 | −11.8 | 4.49 | 2.94 |
| Ink 4/C2 | 1.135 | 1.102 | −3.0 | 0.90 | 0.63 |
| Ink 5/C3 | 1.094 | 0.998 | −8.8 | 4.08 | 2.56 |
| Ink 6/M1 | 1.013 | 0.946 | −6.6 | 3.16 | 1.41 |
| Ink 7/M2 | 1.039 | 0.922 | −11.3 | 4.85 | 2.57 |
| Ink 8/Y1 | 1.218 | 1.086 | −10.8 | 7.15 | 1.52 |
| Ink 9/Y2 | 1.023 | 0.925 | −9.6 | 5.87 | 1.35 |
| Ink 10/K1 | 1.114 | 0.985 | −11.6 | 5.18 | 4.30 |
| Ink 11/C1 | 1.071 | 0.986 | −7.9 | 3.54 | 2.42 |
| Ink 12/M1 | 1.021 | 0.910 | −10.9 | 6.06 | 2.83 |
| Ink 13/Y3 | 1.177 | 1.088 | −7.5 | 6.16 | 1.35 |

Inks 1-9 included Impranil ® DLN-SD.
Inks 10-13 included Dispercoll ® U42.

In Tables 6A to 6E above, washfastness was verified by comparing pre-wash optical density (OD) data with post-wash OD and ΔE_{CIE} or ΔE₂₀₀₀ calculated from pre- and post-wash L*a*b* values. The OD data and the ΔE data was acceptable or good for most inks tested, and in a few instances ΔE_{CIE} values marginally exceeded 7.5 (identified in Example 3 as the upper limit of “acceptable”), the ΔE₂₀₀₀ was considerably lower. Furthermore, with respect to OD, the % ΔOD never exceeded −20% change (after 5 washes) for any ink composition, and in most instances, the % ΔOD on all fabrics was mostly less than −15%. Some ink composition and fabric combinations retained very good OD after 5 washes, e.g., % ΔOD values of less than −10%.

### Example 7

### Kogation

Kogation was evaluated for Inks 1-9 to illustrate that the ink compositions would be reliably jettable, even after a significant number of ink composition drops were ejected from a 12 ng thermal inkjet printhead. The data collected related to initial drop weight and drop velocity, drop weight and drop velocity after 200 million drops per nozzle (MDPN) testing. The data collected is found in Table 7, as follows:

TABLE 7
Kogation

| | Initial | Final | | Initial | Final | |
|---|---|---|---|---|---|---|
| | Drop | Drop | %Δ | Drop | Drop | %Δ |
| Ink | Weight | Weight | Drop | Velocity | Velocity | Drop |
| ID | (ng) | (ng) | Weight | (m/s) | (m/s) | Velocity |
| Ink 1 | 13.01 | 13.05 | 0.3 | 13.14 | 13.20 | 0.5 |
| Ink 2 | 13.50 | 13.27 | −1.7 | 13.26 | 12.50 | −5.7 |
| Ink 3 | 12.63 | 12.25 | −3.0 | 12.04 | 12.01 | −0.2 |
| Ink 4 | 12.02 | 11.56 | −3.8 | 11.35 | 11.04 | −2.7 |
| Ink 5 | 11.86 | 11.55 | −2.7 | 11.30 | 11.08 | −1.9 |
| Ink 6 | 12.77 | 12.24 | −4.1 | 12.48 | 11.95 | −4.2 |
| Ink 7 | 11.84 | 10.70 | −9.6 | 10.86 | 9.91 | −8.7 |
| Ink 8 | 10.95 | 9.68 | −11.6 | 12.25 | 11.15 | −9.0 |
| Ink 9 | 11.22 | 10.76 | −4.0 | 10.93 | 11.01 | 0.7 |

As can be seen in Table 7, the highest reduction in drop weight/drop velocity after 200 MDPN testing was determined to be less than 12%, and drop weight/velocity loss was considerably less than that for some of the inks tested.

While the present technology has been described with reference to certain examples, various modifications, changes, omissions, and substitutions can be made without departing from the spirit of the disclosure. It is intended, therefore, that the disclosure be limited by the scope of the following claims.

What is claimed is:

1. A method of textile printing, comprising:
jetting an ink composition onto a fabric substrate, wherein the ink composition includes water, organic co-solvent, pigment, and from 2 wt % to 15 wt % of a sulfonated polyester-polyurethane binder; and
heating the fabric substrate having the ink composition printed thereon to a temperature from 120° C. to 200° C. for a period of 30 seconds to 5 minutes.

2. The method of claim 1, wherein the sulfonated polyester-polyurethane binder includes diaminesulfonate groups.

3. The method of claim 1, wherein the sulfonated polyester-polyurethane binder has a weight average molecular weight from 20,000 Mw to 300,000 Mw, an acid number from 1 to 50, and an average particle size from 20 nm to 500 nm.

4. The method of claim 1, wherein the sulfonated polyester-polyurethane binder is aliphatic including multiple saturated carbon chain portions ranging from C₄ to C₈ in length and is devoid of aromatic moieties.

5. The method of claim 1, wherein the sulfonated polyester-polyurethane binder is aromatic including both aromatic moieties as well as saturated carbon chain portions ranging from C₄ to C₈ in length.

6. The method of claim 1, wherein the fabric substrate includes cotton, polyester, nylon, or a blend thereof.

7. The method of claim 1, wherein jetting is from a thermal inkjet printhead.

8. A textile printing system, comprising:
a fabric substrate;
an ink composition, comprising:
from 60 wt % to 90 wt % water;
from 5 wt % to 30 wt % organic co-solvent;
from 1 wt % to 6 wt % pigment; and
from 2 wt % to 15 wt % of sulfonated polyester-polyurethane binder.

9. The textile printing system of claim 8, wherein the sulfonated polyester-polyurethane binder includes diaminesulfonate groups.

10. The textile printing system of claim 8, wherein the sulfonated polyester-polyurethane binder has a weight average molecular weight from 20,000 Mw to 300,000 Mw, an acid number from 1 to 50, and an average particle size from 20 nm to 500 nm.

11. The textile printing system of claim 8, wherein the sulfonated polyester-polyurethane binder is aliphatic including multiple saturated carbon chain portions ranging from C₄ to C₈ in length and is devoid of aromatic moieties.

12. The textile printing system of claim 8, wherein the sulfonated polyester-polyurethane binder is aromatic and includes both aromatic moieties as well as saturated carbon chain portions ranging from C₄ to C₈ in length.

13. The textile printing system of claim 8, wherein the fabric substrate includes cotton, polyester, nylon, or a blend thereof.

14. A textile printing system, comprising:
a fabric substrate;
an ink composition including water, organic solvent, pigment, and from 2 wt % to 15 wt % sulfonated polyester-polyurethane binder;
a thermal inkjet printer to thermally eject the ink composition on the fabric substrate; and
a heat curing device to heat the ink composition after application onto the fabric substrate.

15. The textile printing system of claim 14, wherein the fabric substrate includes cotton, polyester, nylon, or a blend thereof.
